(19) United States
(12) Patent Application Publication
(10) Pub. No.: US 2016/0268571 A1
(43) Pub. Date: Sep. 15, 2016

(54) NON-AQEOUS SECONDARY CELL SEPARATOR AND NON-AQUEOUS SECONDARY CELL

(71) Applicant: TEIJIN LIMITED, Osaka-shi (JP)

(72) Inventor: Susumu HONDA, Yamaguchi (JP)

(73) Assignee: TEIJIN LIMITED, Osaka-shi (JP)

(21) Appl. No.: 15/035,058

(22) PCT Filed: Dec. 19, 2014
(86) PCT No.: PCT/JP2014/084731

§ 371 Date: May 6, 2016

(30) Foreign Application Priority Data
Dec. 26, 2013 (JP) 2013-269456

(51) Int. Cl. H01M 2/16; H01M 10/0525

(52) U.S. Cl. CPC H01M 2/1686; H01M 10/0525

(57) ABSTRACT

A separator composed of a composite film including a porous base material containing a thermoplastic resin and a heat-resistant porous layer provided on one surface of the porous base material and containing an organic binder and an inorganic filler, wherein the organic binder is a particulate polyvinylidene fluoride type resin, the heat-resistant porous layer has a porous structure in which the particulate polyvinylidene fluoride type resin and the inorganic filler are connected to each other, the ratio of the thickness Ta of the heat-resistant porous layer to the thickness Tb of the composite film (Ta/Tb) is 0.10 to 0.40, the content of the inorganic filler in the heat-resistant porous layer is 85 to 99 mass % relative to the total mass of the organic binder and the inorganic filler, and the curl amounts of the composite film in the longitudinal direction and the width direction are both 0.5 mm or less.

### TECHNICAL FIELD

The present invention relates to a non-aqueous secondary cell separator and a non-aqueous secondary cell.

### BACKGROUND ART

A non-aqueous secondary cell represented by a lithium ion secondary cell has been widely used as a main power supply for portable electronic apparatuses such as mobile phones and notebook-type personal computers. Further, the application thereof has been expanded to a main power supply for electrical cars and hybrid cars, a power storage system for night-time electricity, and so on. With the spread of the non-aqueous secondary cell, it has become an important issue to ensure stable cell characteristics and safety.

In general, as a non-aqueous secondary cell separator, a porous film containing a polyolefin such as polyethylene or polypropylene as a main component is used. However, a polyolefin porous film has a problem that in the case where a cell is exposed to a high temperature, meltdown occurs in the separator, and therefore, the cell may smoke, fire, or explode. Due to this, the separator is required to have heat resistance to such an extent that meltdown does not occur even under a high temperature.

From such a viewpoint, conventionally, a separator composed of a composite film in which a heat-resistant porous layer containing an inorganic filler and an organic binder is coated on one surface or both surfaces of a porous base material containing a thermoplastic resin such as a polyolefin (hereinafter, appropriately referred to as “thermoplastic resin base material”) has been developed (see, for example, PTL 1 to PTL 9).

Here, from the viewpoint of improvement of the cell capacity, it is preferred to form the separator thinner. From such a viewpoint, a configuration in which a heat-resistant porous layer is coated on one surface of a thermoplastic resin base material as in PTL 3 to PTL 9 is preferred than a configuration in which a heat-resistant porous layer is coated on both surfaces of a thermoplastic resin base material as in PTL 1 and PTL 2.

### CITATION LIST

### Patent Literature

PTL 1: WO 2013/133074

PTL 2: JP-A-2013-8481

PTL 3: WO 2013/80867

PTL 4: JP-A-2012-221889

PTL 5: JP-A-2012-219240

PTL 6: WO 2013/153954

PTL 7: WO 2013/122010

PTL 8: WO 2013/121971

PTL 9: JP-A-2013-235821

### SUMMARY OF INVENTION

### Technical Problem

However, in the case where a heat-resistant porous layer is formed on one surface as in PTL 3 to PTL 9, in order to exhibit the same thermal dimensional stability as in the case where a heat-resistant porous layer is formed on both surfaces, it is necessary to increase the thickness of the heat-resistant porous layer on one surface. However, in such a case, the entire separator is easily curled, and therefore, there is a concern that the efficiency when an electrode element is produced by overlapping and winding a separator and an electrode may be decreased. Further, as the thickness of the heat-resistant porous layer is increased, more moisture is easily adsorbed onto the heat-resistant porous layer. In a cell using a separator containing much moisture, there is a concern that the cycling characteristics of the cell may be deteriorated, or gas swelling may occur.

In this manner, in a configuration in which a heat-resistant porous layer is formed on one surface of a thermoplastic resin base material, it has been desired to solve the conflicting problems of thermal dimensional stability, cell production efficiency, and reduction of moisture amount in a well-balanced manner. However, the current situation is that the problems are not sufficiently solved in the related art as in the above-mentioned PTL 3 to PTL 9.

In light of the above-mentioned problems of the related art, an object of the invention is to provide a non-aqueous secondary cell separator capable of achieving sufficient thermal dimensional stability, a low moisture amount, and improvement of cell production efficiency in a well-balanced manner in a configuration in which a heat-resistant porous layer is formed on one surface of a thermoplastic resin base material.

### Solution to Problem

The invention adopts the following configurations for achieving the above object.

1. A non-aqueous secondary cell separator which is composed of a composite film including a porous base material containing a thermoplastic resin and a heat-resistant porous layer provided on one surface of the porous base material and containing an organic binder and an inorganic filler, wherein the organic binder is a particulate polyvinylidene fluoride type resin, and the heat-resistant porous layer has a porous structure in which the particulate polyvinylidene fluoride type resin and the inorganic filler are connected to each other, the ratio of the thickness Ta of the heat-resistant porous layer to the thickness Tb of the composite film (Ta/Tb) is 0.10 or more and 0.40 or less, the content of the inorganic filler in the heat-resistant porous layer is 85 mass % or more and 99 mass % or less with respect to the total mass of the organic binder and the inorganic filler, and the curl amounts of the composite film in the longitudinal direction and in the width direction are both 0.5 mm or less.

2. The non-aqueous secondary cell separator according to the above 1, wherein the thermal shrinkage rate of the composite film in the longitudinal direction and in the width direction when the composite film is subjected to a thermal treatment at 120° C. for 60 minutes is 3% or less.

3. The non-aqueous secondary cell separator according to the above 1 or 2, wherein the moisture amount in the composite film is 2,000 ppm or less.

4. The non-aqueous secondary cell separator according to any one of the above 1 to 3, wherein a value obtained by subtracting the Gurley value of the porous base material from the Gurley value of the composite film is 30 sec/100 cc or less.

5. The non-aqueous secondary cell separator according to any one of the above 1 to 4, wherein the heat-resistant porous layer further contains a thickener.

6. The non-aqueous secondary cell separator according to any one of the above 1 to 5, wherein the thickness Ta of the heat-resistant porous layer is 2 μm or more and less than 8 μm.

7. A non-aqueous secondary cell comprising a positive electrode, a negative electrode, and the non-aqueous secondary cell separator according to any one of the above 1 to 6 disposed between the positive electrode and the negative electrode, wherein an electromotive force is obtained by doping and dedoping of lithium.

### Advantageous Effects of Invention

According to the invention, a non-aqueous secondary cell separator capable of achieving sufficient thermal dimensional stability, a low moisture amount, and improvement of cell production efficiency in a well-balanced manner in a configuration in which a heat-resistant porous layer is formed on one surface of a thermoplastic resin base material can be provided.

### BRIEF DESCRIPTION OF DRAWINGS

FIG. 1 is a plan view schematically showing the placement of a sample when the curl amount in the MD direction of a separator is measured.

FIG. 2 is a side view schematically showing the placement of a sample when the float amount of a separator is measured.

FIG. 3 is a plan view schematically showing the placement of a sample when the curl amount in the TD direction of a separator is measured.

FIG. 4 is an SEM image of the surface of a porous base material after peeling off a heat-resistant porous layer taken from a direction perpendicular to the surface in a separator of Example 1.

FIG. 5 is an SEM image of the surface of a porous base material after peeling off a heat-resistant porous layer taken from a direction perpendicular to the surface in a separator of Comparative Example 1.

### DESCRIPTION OF EMBODIMENTS

Hereinafter, embodiments of the invention will be sequentially described. Incidentally, the description and Examples are merely illustrative of the invention and do not limit the scope of the invention. Note that, a numerical range represented by using “to” in this description indicates a range including the numerical values described before and after “to” as the minimum value and the maximum value, respectively. Further, with respect to the separator of the invention, the “longitudinal direction” means a long direction of the separator produced in an elongated shape, and the “width direction” means a direction orthogonal to the longitudinal direction of the separator. Hereinafter, the “width direction” is also referred to as “TD direction”, and the “longitudinal direction” is also referred to as “MD direction”.

### <Non-Aqueous Secondary Cell Separator>

The non-aqueous secondary cell separator of the invention is composed of a composite film including a porous base material containing a thermoplastic resin and a heat-resistant porous layer provided on one surface of the porous base material and containing an organic binder and an inorganic filler, wherein the organic binder is a particulate polyvinylidene fluoride type resin, and the heat-resistant porous layer has a porous structure in which the particulate polyvinylidene fluoride resin and the inorganic filler are connected to each other, the ratio of the thickness Ta of the heat-resistant porous layer to the thickness Tb of the composite film (Ta/Tb) is 0.10 or more and 0.40 or less, the content of the inorganic filler in the heat-resistant porous layer is 85 mass % or more and 99 mass % or less with respect to the total mass of the organic binder and the inorganic filler, and the curl amounts of the composite film in the longitudinal direction and in the width direction are both 0.5 mm or less.

Such a separator of the invention can achieve sufficient thermal dimensional stability, a low moisture amount, and improvement of cell production efficiency in a well-balanced manner even in a configuration in which a heat-resistant porous layer is formed on one surface of a thermoplastic resin base material. Further, the heat-resistant porous layer is laminated on only one surface of the porous base material, and therefore, the film thickness of the entire separator can be suppressed to be small, and thus, it can contribute to the improvement of the cell capacity, and because the number of laminated layers is small, favorable ion permeability is easily obtained. Then, by using such a separator of the invention, the problem of the generation of a gas or the decrease in cycling characteristics can be prevented, and a cell having also excellent safety under a high temperature is obtained. Further, in the case where an electrode element is produced by overlapping and winding a separator and an electrode, the rate of defective products can be decreased, and the cell production efficiency can be improved. The reason why the cell production efficiency is improved in the invention is considered to be because the curl amount of the separator is small, and therefore, when the separator and the electrode are overlapped and wound, the misalignment of the position of the separator is small, the heat-resistant porous layer is formed on only one surface, and therefore, when the winding core is pulled out from the electrode element, the winding core slides favorably and the deformation of the electrode element is reduced, and so on. Incidentally, in a configuration in which the heat-resistant porous layer is formed on both surfaces of the thermoplastic resin base material, when the winding core is pulled out from the electrode element, the sliding between the heat-resistant porous layer and the winding core is poor, and the deformation of the electrode element occurs in some cases.

### [Porous Base Material]

In the invention, the porous base material means a base material having pores or voids therein. Examples of such a base material include a microporous film; a porous sheet composed of a fibrous material such as a nonwoven fabric, or a paper sheet; and the like. In particular, from the viewpoint of reduction in the thickness and enhancement of the strength of the separator, a microporous film is preferred.

Incidentally, the microporous film means a film having a structure in which a lot of micropores are included therein and these micropores are connected to each other, and capable of allowing a gas or a liquid to permeate the film from one surface to the other surface.

A material constituting the porous base material is a thermoplastic resin, and specific examples thereof include a polyester such as polyethylene terephthalate; a polyolefin such as polyethylene and polypropylene; and the like. From the viewpoint of imparting a shutdown function, the thermoplastic resin is suitably a thermoplastic resin which has a flow elongation deformation temperature lower than 200° C. Incidentally, the shutdown function refers to a function to block the movement of ions by closing the pores of the porous base material by dissolving the thermoplastic resin so as to prevent the thermal runaway of the cell.

In particular, as the porous base material, a polyolefin microporous film containing a polyolefin is preferred. As the polyolefin microporous film, a polyolefin microporous film having sufficient mechanical properties and ion permeability may be selected from the polyolefin microporous films used in the non-aqueous secondary cells separator of the related art. From the viewpoint of exhibiting the shutdown function, the polyolefin microporous film preferably contains polyethylene, and the content of polyethylene is preferably 95 mass % or more.

In addition, from the viewpoint of imparting the heat resistance to such an extent that the film is not easily broken when the film is exposed to a high temperature, a polyolefin microporous film containing polyethylene and polypropylene is preferred. Examples of such a polyolefin microporous film include a microporous film in which polyethylene and polypropylene are mixed in one layer. In such a microporous film, from the viewpoint of achieving both shutdown function and heat resistance, it is preferred that polyethylene is contained in an amount of 95 mass % or more and polypropylene is contained in an amount of 5 mass % or less. Further, from the viewpoint of achieving both shutdown function and heat resistance, a polyolefin microporous film which has a laminated structure of two or more layers, and has a structure in which at least one layer contains polyethylene and at least one layer contains polypropylene is also preferred.

The polyolefin to be contained in the polyolefin microporous film is preferably a polyolefin having a weight average molecular weight (Mw) of 100,000 to 5,000,000. When the weight average molecular weight is 100,000 or more, sufficient mechanical properties can be ensured. On the other hand, when the weight average molecular weight is 5,000,000 or less, the shutdown characteristics are favorable and also the film is easy to form.

The polyolefin microporous film can be produced by, for example, the following method. That is, a method of forming a microporous film by sequentially performing (i) a step of extruding a melted polyolefin resin from a T-die, thereby forming a sheet, (ii) a step of subjecting the sheet to a crystallization treatment, (iii) a step of stretching the sheet, and (iv) a step of subjecting the sheet to a thermal treatment can be exemplified.

Further, a method of forming a microporous film by sequentially performing (i) a step of melting a polyolefin resin along with a plasticizer such as liquid paraffin, extruding the melted material from a T-die, and cooling the extruded material, thereby forming a sheet, (ii) a step of stretching the sheet, (iii) a step of extracting the plasticizer from the sheet, and (iv) a step of subjecting the sheet to a thermal treatment, and the like can also be exemplified.

Examples of the porous sheet composed of a fibrous material include a porous sheet such as a nonwoven fabric and a paper composed of a fibrous material of a thermoplastic resin.

In the invention, the thickness of the porous base material is preferably from 3 μm to 25 μm from the viewpoint of obtaining favorable mechanical properties and internal resistance. In particular, the film thickness of the porous base material is preferably from 5 μm to 20 μm.

The Gurley value (JIS P 8117) of the porous base material is preferably in the range of 50 sec/100 cc to 400 sec/100 cc from the viewpoint of preventing a short circuit of the cell and obtaining sufficient ion permeability.

The porosity of the porous base material is preferably from 20% to 60% from the viewpoint of obtaining appropriate film resistance and shutdown function.

The piercing strength of the porous base material is preferably 200 g or more from the viewpoint of improving the production yield.

The porous base material can also be subjected to various surface treatments for the purpose of improving the wettability to the below-mentioned coating liquid containing an organic binder and an inorganic filler. Specific examples of the surface treatment include a corona treatment, a plasma treatment, a flame treatment, and a UV irradiation treatment, and the treatment can be performed within a range not impairing the properties of the porous base material.

### [Heat-Resistant Porous Layer]

The heat-resistant porous layer in the invention is provided on one surface of the porous base material and is configured to include an organic binder composed of a particulate polyvinylidene fluoride type resin and an inorganic filler, and has a porous structure in which the particulate polyvinylidene fluoride type resin and the inorganic filler are connected to each other. Here, the heat resistance refers to a property such that melting, decomposition, or the like does not occur in a temperature range lower than 150° C.

Such a porous structure is preferred from the viewpoint of having excellent ion permeability and heat resistance, and also improving the productivity of the separator. More specifically, the porous structure refers to a structure in a state where the organic binder particles are fixed to the porous base material, and further, the adjacent organic binder particles or the organic binder particle and the inorganic filler are connected to each other so as to form pores among the particles, so that an aggregate of the organic binder particles and the inorganic filler has a porous structure as a whole.

### (Organic Binder)

In the invention, the organic binder is composed of a particulate polyvinylidene fluoride type resin.

As the polyvinylidene fluoride type resin, a homopolymer of vinylidene fluoride, that is, polyvinylidene fluoride, or a copolymer of vinylidene fluoride and another monomer copolymerizable with the vinylidene fluoride, a mixture of polyvinylidene fluoride and an acrylic polymer, or a mixture of a polyvinylidene fluoride copolymer and an acrylic polymer can be used.

The monomer copolymerizable with vinylidene fluoride is not particularly limited, however, examples thereof include vinyl fluoride, chlorotrifluoroethylene, tetrafluoroethylene, hexafluoropropylene, triflucroethylene, trichloroethylene, trifluoroperfluoropropyl ether, ethylene, (meth)acrylic acid, (meth)acrylate esters such as methyl (meth)acrylate and ethyl (meth)acrylate, vinyl acetate, vinyl chloride, and acrylonitrile. These can be used alone or in combination of two or more types. Incidentally, the (meth)acrylate means acrylate or methacrylate.

The acrylic polymer is not particularly limited, however, examples thereof include polyacrylic acid, polyacrylate salts, polyacrylate esters, crosslinked polyacrylic acid, crosslinked polyacrylate salts, crosslinked polyacrylate esters, polymethacrylate esters, crosslinked polymethacrylic acid, crosslinked polymethacrylate salts, and crosslinked polymethacrylate esters, and a modified acrylic polymer can also be used. These can be used alone or in combination of two or more types. In particular, polyvinylidene fluoride, a copolymer of vinylidene fluoride and tetrafluoroethylene, a copolymer of vinylidene fluoride and hexafluoropropylene, a copolymer of vinylidene fluoride and trifluoroethylene, a mixture of polyvinylidene fluoride and an acrylic polymer, or a mixture of a polyvinylidene fluoride copolymer and an acrylic polymer is preferred.

The polyvinylidene fluoride copolymer is preferably a copolymer having, as a constituent unit, a vinylidene fluoride-derived constituent unit in an amount of 50 mol % or more with respect to the total constituent units. By incorporating the polyvinylidene fluoride type resin containing vinylidene fluoride in an amount of 50 mol % or more, a bonded region can ensure sufficient mechanical properties even after the separator and the electrode are press bonded or hot pressed in a state where the separator and the electrode are overlapped.

It is preferred that in a mixture of polyvinylidene fluoride and an acrylic polymer or a mixture of a polyvinylidene fluoride copolymer and an acrylic polymer, the polyvinylidene fluoride or the vinylidene fluoride copolymer is contained in an amount of 20 mass % or more from the viewpoint of oxidation resistance.

The average particle diameter of the particulate organic binder is preferably from 0.01 μm to 1 μm, more preferably from 0.02 μm to 1 μm, particularly preferably from 0.05 μm to 1 μm from the viewpoint of handleability and productivity.

### (Inorganic Filler)

In the invention, the inorganic filler is not particularly limited as long as it is stable with respect to an electrolyte and also is electrochemically stable. Specific examples thereof include metal hydroxides such as aluminum hydroxide, magnesium hydroxide, calcium hydroxide, chromium hydroxide, zirconium hydroxide, cerium hydroxide, nickel hydroxide, and boron hydroxide; metal oxides such as alumina, zirconia, and magnesium oxide; carbonate salts such as calcium carbonate and magnesium carbonate; sulfate salts such as barium sulfate and calcium sulfate; and clay minerals such as calcium silicate and talc. Among these, the inorganic filler is preferably composed of at least one of a metal hydroxide and a metal oxide. In particular, it is preferred to use a metal hydroxide from the viewpoint of imparting flame retardancy and obtaining an electricity removing effect. The above-mentioned various fillers may be used alone or in combination or two or more types. Among the fillers described above, from the viewpoint of suppressing the reaction with the electrolyte and preventing the generation of a gas, one or more types of fillers selected from the group consisting of magnesium hydroxide, magnesium oxide, and magnesium carbonate (hereinafter, referred to as “magnesium-based filler”) are preferred. In addition, it is also possible to use an inorganic filler subjected to surface modification by a silane coupling agent or the like.

The average particle diameter of the inorganic filler is preferably 0.01 μm or more and 10 μm or less. The lower limit thereof is more preferably 0.1 μm or more and the upper limit thereof is more preferably 5 μm or less.

The particle size distribution of the inorganic filler is preferably 0.1<d90-d10<3 μm. Here, d10 represents the average particle diameter (μm) when the cumulative total mass calculated from a small particle side reaches 10 mass % in a particle size distribution in a laser diffraction system, and d90 represents the average particle diameter (nm) when the cumulative total mass reaches 90 mass %. In the measurement of the particle size distribution, for example, a laser diffraction particle size distribution measuring device (Mastersizer 2000, manufactured by Sysmex Corporation) is used, and a method in which water is used as a dispersion medium, and a small amount of a nonionic surfactant Triton X-100 is used as a dispersant can be exemplified.

As for the shape of the inorganic filler, the inorganic filler may have, for example, a shape close to a spherical shape or a plate shape, however, from the viewpoint of preventing a short circuit, the shape is preferably a plate-shaped particle or a primary particle which is not aggregated.

### (Thickener)

The heat-resistant porous layer in the invention may further contain a thickener. By containing a thickener, it is possible to improve the dispersibility of the particles or the filler, and the morphology of the heat-resistant porous layer is easily made homogeneous.

As the thickener, for example, cellulose and/or a cellulose salt, a resin of polyvinyl alcohol, polyvinyl butyral, polyvinylpyrrolidone, polyethylene glycol, polypropylene glycol, a polyacrylic acid, a higher alcohol, or the like, and a salt thereof can be used in combination. Among these, cellulose and/or a cellulose salt are/is preferred. The cellulose and/or the cellulose salt are/is not particularly limited, however, examples thereof include carboxymethyl cellulose, hydroxyethyl cellulose, hydroxypropyl cellulose, methyl cellulose, and a sodium salt thereof and an ammonium salt thereof.

In the invention, the mass of the thickener with respect to the total mass of the organic binder, the inorganic filler, and the thickener is preferably 10 mass % or less, more preferably 5 mass % or less. When the content of the thickener is 10 mass % or less, excellent thermal dimensional stability, air permeability, and moisture amount are obtained.

### (Other Additives)

Incidentally, to the heat-resistant porous layer in the invention, further an additive composed of another inorganic compound or organic compound can also be added as needed within a range not impairing the effect of the invention. In this case, the porous layer can be configured to be constituted by the organic binder and the inorganic filler, which make up about 90 mass % or more of the total layer, and include additives as the remainder.

The heat-resistant porous layer in the invention may contain a dispersant such as a surfactant, and it is possible to improve the dispersibility, coatability, and storage stability. In addition, in the heat-resistant porous layer in the invention, various additives such as a wetting agent for enhancing the compatibility with the porous base material, an antifoaming agent for preventing air entrainment into a coating liquid, and a pH adjusting agent containing an acid or an alkali may be contained. Such an additive may remain therein as long as it is electrochemically stable and does not inhibit the reaction in the cell within the range of use of a lithium ion secondary cell.

### (Various Characteristics of Heat-Resistant Porous Layer)

In the invention, the content of the inorganic filler in the heat-resistant porous layer is 85 mass % or more and 99 mass % or less with respect to the total mass of the organic binder and the inorganic filler. When the content of the inorganic filler is 85 mass % or more, excellent thermal dimensional stability and air permeability are obtained. From such a viewpoint, the content of the inorganic filler is more preferably 90 mass % or more. In addition, when the content of the inorganic filler is 99 mass % or less, the powder falling of the inorganic filler or the peel-off of the heat-resistant porous layer can be prevented, and excellent thermal dimensional stability can be maintained. From such a viewpoint, the content of the inorganic filler is preferably 98.5 mass % or less, more preferably 98 mass % or less.

In the invention, the film thickness Ta of the heat-resistant porous layer is preferably 2.0 μm or more and less than 8.0 μm from the viewpoint of thermal dimensional stability, moisture amount, curl amount, and cell capacity. When the film thickness Ta of the heat-resistant porous layer is 2.0 μm or more, sufficient thermal dimensional stability is obtained, and from such a viewpoint, the film thickness Ta is preferably 2.1 μm or more, more preferably 2.2 μm or more. Further, when the film thickness Ta of the heat-resistant porous layer is less than 8.0 μm, the curl amount of the separator and the moisture amount can be reduced, and from such a viewpoint, the film thickness Ta is preferably 7.9 μm or less.

The porosity of the heat-resistant porous layer is preferably from 40 to 80%, more preferably from 45 to 75% from the viewpoint of obtaining favorable heat resistance and ion permeability.

### [Various Characteristics of Composite Film]

In the invention, it is important that the curl amounts of the composite film (separator) in the longitudinal direction and in the width direction are both 0.5 mm or less. By reducing the curl amount of the composite film to 0.5 mm or less, in the case where an electrode element is produced by overlapping and winding a separator and an electrode, the rate of defective products can be decreased, and the cell production efficiency can be improved.

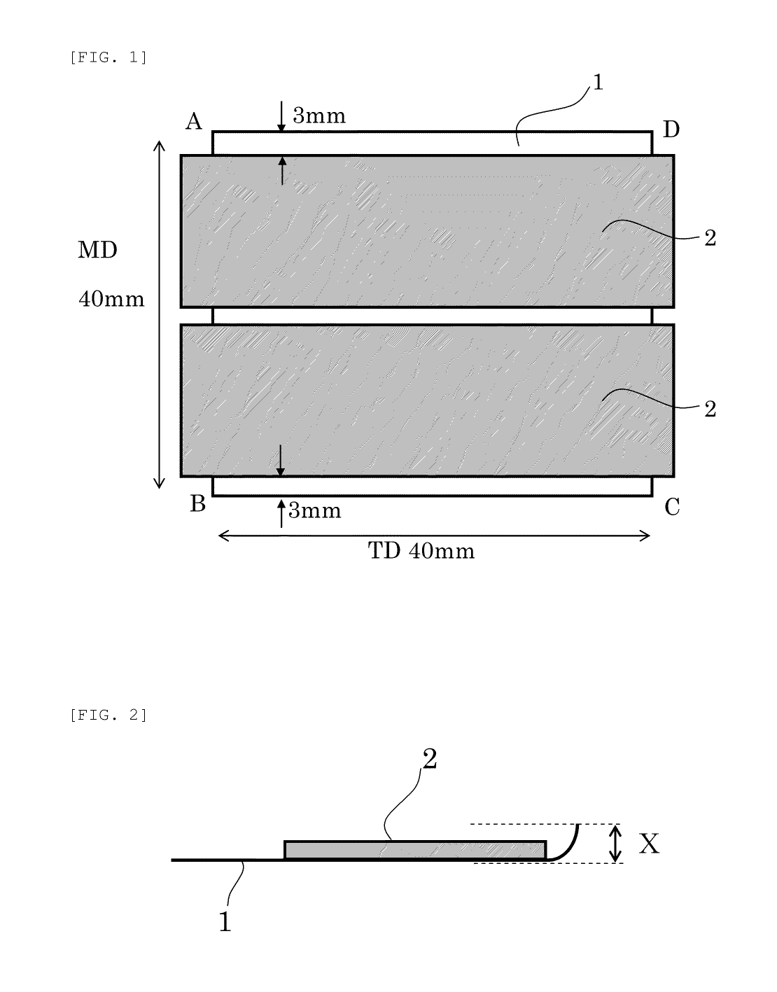

Here, the curl amount in the invention is obtained as follows. First, the separator is cut into a size of 40 mm along the MD direction and 40 mm along the TD direction, whereby a sample is prepared. The electricity is removed from this sample by a static eliminator for 10 seconds, and the sample is placed on a planar metal plate with the heat-resistant porous layer facing down. Subsequently, as shown in FIG. 1, a planar weight 2 is placed on a sample 1 such that one edge portion of the sample 1 in the MD direction (A and D in FIG. 1) protrudes by 3 mm. The weight weighs 4.5 g, and has a size of 76 mm in length, 26 mm in width, and 1 mm in height. Then, as shown in FIG. 2, the float amount X of the sample 1 at each vertex (A and D in FIG. 1) is measured by digital venire calipers. Subsequently, a weight 2 is placed such that the other edge portion of the sample 1 in the MD direction (B and C in FIG. 1) protrudes by 3 mm, and the float amount X of the sample 1 at each vertex (B and C in FIG. 1) is measured by digital venire calipers in the same manner. Then, from the float amounts X of the sample 1 at all the vertices (A, B, C, and D in FIG. 1), the curl amount is calculated according to the following formula 1.

Curl amount=(maximum value of float amount X+minimum value of float amount X)/2 (formula 1)

Incidentally, the float amount X is the amount of height of the curl of the edge portion of the sample in a direction away from the surface of the metal plate, and is a length from the surface of the metal plate to the edge portion of the sample in a direction perpendicular to the surface. Further, the measurement of the float amount is performed in a windless state at room temperature of 23 to 27° C. and a humidity of 40 to 60%. This procedure is performed for 5 samples prepared for each separator, and by calculating an average value of the curl amounts of the 5 samples, the curl amount in the MD direction can be obtained.

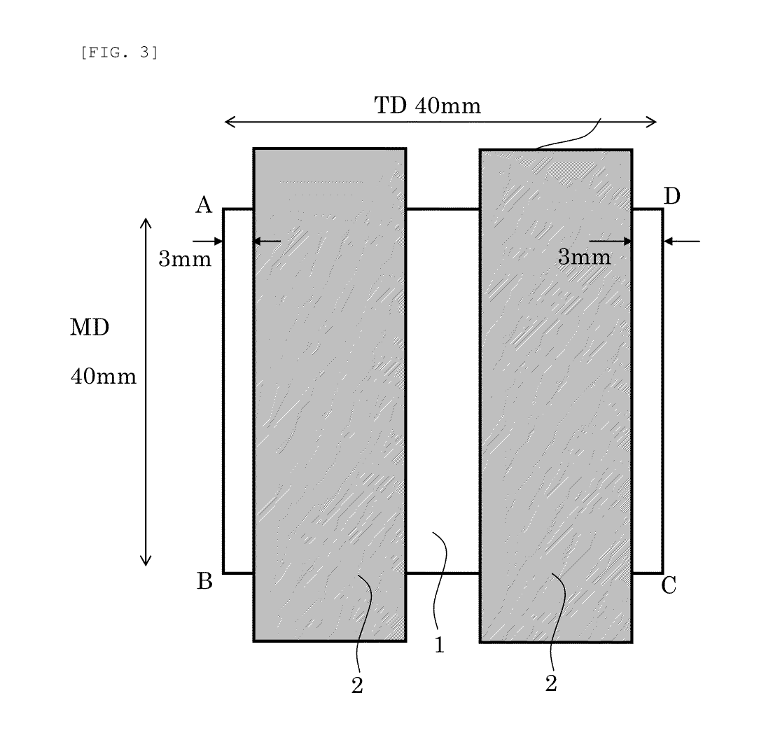

Also the curl amount in the TD direction can be obtained in the same manner, and as shown in FIG. 3, a planar weight 2 is placed on a sample 1 such that one edge portion of the sample 1 in the TD direction (A and B in FIG. 3) protrudes by 3 mm, and the float amount X at each vertex (A and B in FIG. 3) is measured. Subsequently, a planar weight 2 is placed on the sample 1 such that the other edge portion of the sample 1 in the TD direction (C and D in FIG. 3) protrudes by 3 mm, and the float amount X at each vertex (C and D in FIG. 3) is measured. Then, from the float amounts X at the four vertices (A, B, C, and D in FIG. 3), the curl amount is obtained according to the above formula 1, and by calculating an average value of the curl amounts of the 5 samples, the curl amount in the TD direction can be obtained.

A method of controlling the curl amount of the composite film is not particularly limited, however, examples thereof include a method in which the thickness of the heat-resistant porous layer and the ratio of the thickness Ta of the heat-resistant porous layer to the thickness Tb of the composite film are controlled within predetermined ranges, and a method in which the morphology (porous structure) of the heat-resistant porous layer is formed uniformly.

In the invention, by setting the ratio of the thickness Ta of the heat-resistant porous layer to the thickness Tb of the composite film (Ta/Tb) to 0.10 or more and 0.40 or less, the curl amount is easily controlled within the range of the invention. When Ta/Tb is 0.10 or more, the thermal dimensional stability becomes favorable, and from such a viewpoint, Ta/Tb is more preferably 0.15 or more. When Ta/Tb is 0.40 or less, the curl amount is easily decreased, and from such a viewpoint, Ta/Tb is more preferably 0.35 or less.

In the composite film in which the heat-resistant porous layer is provided on only one surface of the porous base material, as the morphology of the heat-resistant porous layer is more uniform, the curl amount tends to decrease. It can be determined whether or not the morphology of the heat-resistant porous layer is uniform from, for example, a value obtained by subtracting the Gurley value of the porous base material from the Gurley value of the composite film. Here, the uniformity of the morphology of the heat-resistant porous layer refers to the uniformity in the thickness direction of the heat-resistant porous layer.

In the invention, from the viewpoint of the above-mentioned uniformity of the morphology of the heat-resistant porous layer, the value obtained by subtracting the Gurley value of the porous base material from the Gurley value of the composite film is preferably 30 sec/100 cc or less, more preferably 25 sec/100 cc or less, further more preferably 20 sec/100 cc or less. When the organic binder in the heat-resistant porous layer is unevenly distributed at the interface between the porous base material and the heat-resistant porous layer, the value obtained by subtracting the Gurley value of the porous base material from the Gurley value of the composite film tends to increase.

Further, it is also possible to determine whether or not the morphology of the heat-resistant porous layer is uniform by, for example, peeling off the heat-resistant porous layer from the porous base material, observing the porous base material, and confirming the amount of the residual material of the heat-resistant porous layer adhered to the surface of the porous base material. In the case where the morphology of the heat-resistant porous layer is uniform, the amount of the residual material of the heat-resistant porous layer on the porous base material after peeling off the heat-resistant porous layer is decreased. In the case where the amount of the residual material is large, the heat-resistant porous layer is not uniformly peeled off, that is, the uniformity of the morphology of the heat-resistant porous layer is poor.

Incidentally, a method of controlling the morphology of the heat-resistant porous layer is not particularly limited, however, examples thereof include a method in which the fluidity of the coating liquid at the time of forming the heat-resistant porous layer is controlled to be the same on the surface side and on the base material side by adjusting the viscosity of the coating liquid by adding a thickener to the coating liquid, adjusting the concentration of the organic binder, or the like, or by adjusting the drying conditions of the coating liquid.

In the invention, by setting the peel strength between the heat-resistant porous layer and the porous base material to 0.05 N/cm or more and 1.0 N/cm or less, the curl amount is easily controlled within the range of the invention. When the peel strength is 0.05 N/cm or more, the adhesiveness between the heat-resistant porous layer and the porous base material becomes favorable, and from such a viewpoint, the peel strength is more preferably 0.1 N/cm or more. When the peel strength is 1.0 N/cm or less, the curl amount is easily decreased, and from such a viewpoint, the peel strength is more preferably 0.8 N/cm or less.

In the invention, the film resistance of the composite film is preferably 5 Ω·cm² or less. When the film resistance of the composite film is 5 Ω·cm² or less, the ion permeability becomes favorable, and the cell characteristics such as the rate characteristics can be improved. In addition, a difference between the film resistance of the composite film and the film resistance of the porous base material is preferably 2 Ω·cm² or less.

In the invention, the composite film including the heat-resistant porous base material and the porous base material is preferably configured such that when the composite film is subjected to a thermal treatment at 120° C. for 60 minutes, the thermal shrinkage rate in the longitudinal direction (MD direction) and in the width direction (TD direction) of the composite film is 3% or less. Here, in the measurement of the thermal shrinkage rate, first, a separator to be a sample is cut into a size of 18 cm (MD direction)×6 cm (TD direction). A mark is attached on a line bisecting the length in the TD direction at points (point A and point B) at a distance of 2 cm and 17 cm from the upper portion. In addition, a mark is attached on a line bisecting the length in the MD direction at points (point C and point D) at a distance of 1 cm and 5 cm from the left. A clip is attached to the sample (the place to which the clip is attached is within a distance of 2 cm from the upper portion in the MD direction) and the sample is suspended in an oven adjusted to 120° C., and a thermal treatment is performed for 60 minutes under tensionless conditions. The lengths between the two points A and B and the two points C and D are measured before and after the thermal treatment, and the thermal shrinkage rate is obtained according to the following formula.

Thermal shrinkage rate in MD direction={(length between A and B before thermal treatment−length between A and B after thermal treatment)/length between A and B before thermal treatment}×100

Thermal shrinkage rate in TD direction={(length between C and D before thermal treatment−length between C and D after thermal treatment)/length between C and D before thermal treatment}×100

When the thermal shrinkage rate in the MD direction and in the TD direction is 3% or less, for example, in the case where the cell is produced, even if the cell is exposed to a high temperature, a short circuit hardly occurs, and thus, highly stable heat resistance can be imparted. From such a viewpoint, the thermal shrinkage rate in the MD direction and in the TD direction is more preferably within 2%.

In the invention, the amount of moisture contained in the composite film is preferably 2,000 ppm or less. As the amount of moisture in the composite film is smaller, in the case where the cell is formed, the reaction between the electrolyte and water can be suppressed, and thus, the generation of a gas in the cell can be suppressed, and the cycling characteristics of the cell can also be improved. From such a viewpoint, the amount of moisture contained in the composite film is more preferably 1,500 ppm or less, further more preferably 1,000 ppm or less. Examples of a method of controlling the amount of moisture in the composite film include, in addition to the above-mentioned thickness of the heat-resistant porous layer, the type of the organic binder, the thickener, or the inorganic filler to be used, and the drying conditions when the composite film is produced.

In the invention, the Gurley value of the composite film is preferably 400 sec/100 cc or less from the viewpoint of ion permeability.

The film thickness of the composite film is preferably 30 μm or less, more preferably 25 μm or less from the viewpoint of energy density and output characteristics of the cell. The piercing strength of the composite film is preferably from 300 g to 1000 g, more preferably in the range from 300 g to 600 g.

### <Method of Producing Non-Aqueous Secondary Cell Separator>

In the invention, a method of producing the non-aqueous secondary cell separator is not particularly limited, however, for example, it is possible to produce the non-aqueous secondary cell separator by a method sequentially performing the following steps (1) to (3).

### (1) Slurry Preparation Step

Each of the organic binder and the inorganic filler is dispersed, suspended, or emulsified in a solvent in a solid state, whereby a slurry is prepared. In this case, the slurry may be an emulsion or a suspension. As the solvent, at least water is used, and a solvent other than water may be used. The solvent other than water is not particularly limited, however, examples thereof include alcohols such as methanol, ethanol, and 2-propanol, and organic solvents such as acetone, tetrahydrofuran, methyl ethyl ketone, ethyl acetate, N-methylpyrrolidone, dimethylacetamide, dimethylformamide, and dimethylformamide. It is preferred to use water or an aqueous emulsion obtained by dispersing the organic binder and the inorganic filler in a mixed liquid of water and an alcohol from the viewpoint of productivity or environmental protection. In addition, a well-known thickener may be further contained in an amount of 0.1 to 10 mass % within the range capable of ensuring an appropriate viscosity for coating. Further, a well-known surfactant may be contained in order to improve the dispersibility of the organic binder and the inorganic filler.

The content of the organic binder in the slurry is preferably from 1 to 10 mass %. The content of the inorganic filler in the slurry is preferably from 4 to 50 mass %.

### (2) Coating Step

The above slurry is coated on one surface of the porous base material. Examples of a method of coating the slurry for coating include a knife coater method, a gravure coater method, a Mayer bar method, a die coater method, a reverse roll coater method, a roll coater method, a screen printing method, an ink jet method, and a spray method. Among these, a reverse roll coater method is preferred from the viewpoint of uniformly forming a coated layer.

### (3) Drying Step

The coated film after the above coating is dried to remove the solvent, and the heat-resistant porous layer in which the organic binder and the inorganic filler are connected to each other is formed. It is preferred that the organic binder in the heat-resistant porous layer obtained through the drying step preferably has a particulate shape. By performing the drying step, the organic binder functions as a binder and the entire heat-resistant porous layer is integrally formed on the porous base material.

### <Non-Aqueous Secondary Cell>

A non-aqueous secondary cell of the invention includes the above-mentioned separator of the invention.

Specifically, the non-aqueous secondary cell of the invention includes a positive electrode, a negative electrode, and the non-aqueous secondary cell separator of the invention disposed between the positive electrode and the negative electrode, and obtains an electromotive force by doping and dedoping of lithium.

In the invention, in the non-aqueous secondary cell, the separator is disposed between the positive electrode and the negative electrode and these cell elements are enclosed in an outer package along with an electrolyte. As the non-aqueous secondary cell, a lithium ion secondary cell is suitable. Incidentally, the doping means occlusion, support, adsorption, or insertion and means a phenomenon in which lithium ions enter an active material of an electrode such as a positive electrode.

The positive electrode may have a structure in which an active material layer including a positive electrode active material and a binder resin is formed on a current collector. The active material layer may further contain a conductive assistant. Examples of the positive electrode active material include a lithium-containing transition metal oxide, and specific examples thereof include LiCoO₂, LiNiO₂, LiMn_{1/2}N_{1/2}O₂, LiCo_{1/3}Mn_{1/3}Ni_{1/3}O₂, LiMn₂O₄, LiFePO₄, LiCo_{1/2}Ni_{1/2}O₂, and LiAl_{1/4}Ni_{3/4}O₂. Examples of the binder resin include a polyvinylidene fluoride type resin. Examples of the conductive assistant include carbon materials such as acetylene black, Ketchen black, and graphite powder. Examples of the current collector include an aluminum foil, a titanium foil, and a stainless steel foil having a thickness of 5 μm to 20 μm.

In the non-aqueous secondary cell of the invention, in the case where the heat-resistant porous layer of the separator is disposed on the positive electrode side, the layer has excellent oxidation resistance, and therefore, the positive electrode active material such as LiMn_{1/2}Ni_{1/2}O₂ or LiCo_{1/3}Mn_{1/3}Ni_{1/3}O₂ which can operate at a high voltage of 4.2 V or more can be easily applied, and thus, such a case is advantageous.

The negative electrode may have a structure in which an active material layer including a negative electrode active material and a binder resin is formed on a current collector. The active material layer may further contain a conductive assistant. Examples of the negative electrode active material include a material which can electrochemically occlude lithium, and specific examples thereof include a carbon material; and an alloy of silicon, tin, aluminum, or the like and lithium. Examples of the binder resin include a polyvinylidene fluoride type resin and styrene-butadiene rubber. Examples of the conductive assistant include carbon materials such as acetylene black, Ketchen black, and graphite powder. Examples of the current collector include a copper foil, a nickel foil, and a stainless steel foil having a thickness of 5 μm to 20 μm. In addition, a metal lithium foil may be used as the negative electrode in place of the above-mentioned negative electrode.

The electrolyte is a solution obtained by dissolving a lithium salt in a non-aqueous solvent. Examples of the lithium salt include LiPF₆, LiBF₄, and LiClO₄. Examples of the non-aqueous solvent include cyclic carbonates such as ethylene carbonate, propylene carbonate, fluoroethylene carbonate, difluoroethylene carbonate, and vinylene carbonate; chain carbonates such as dimethyl carbonate, diethyl carbonate, ethyl methyl carbonate, and a fluorine-substituted compound thereof; cyclic esters such as γ-butyrolactone and γ-valerolactone; and the like, and these may be used alone or in a mixture. As the electrolyte, an electrolyte obtained by mixing a cyclic carbonate and a chain carbonate at a mass ratio (cyclic carbonate/chain carbonate) of 20/80 to 40/60 and dissolving a lithium salt therein at 0.5 M to 1.5 M.

Examples of an outer package material include a metal can and an aluminum laminated film package. The shape of the cell includes a square shape, a cylindrical shape, a coin shape, and the like, and the separator of the invention is suitable for any shape.

The non-aqueous secondary cell of the invention can be produced by, for example, impregnating a laminate in which the separator of the invention is disposed between the positive electrode and the negative electrode with the electrolyte, housing the laminate in an outer package material (for example, an aluminum laminated film package), and pressing the laminate from the upper side of the outer package material.

A method of disposing the separator between the positive electrode and the negative electrode may be a method of laminating the positive electrode, the separator, and the negative electrode at least one by one in this order (a so-called stacking method), or may be a method of overlapping the positive electrode, the separator, the negative electrode, and the separator in this order and winding those members in the longitudinal direction.

### EXAMPLES

Hereinafter, the invention will be described with reference to Examples. However, the invention is not limited to the following Examples.

### [Measurement Method]

### (Film Thickness)

The film thickness was measured using a contact-type thickness meter (LITEMATIC manufactured by Mitutoyo Corporation). As the measurement terminal, a cylindrical measurement terminal having a diameter of 5 mm was used, and the adjustment was performed such that a load of 7 g was applied thereto during the measurement. An average value of the thickness at 20 points was obtained. The film thickness of the heat-resistant porous layer was obtained by subtracting the film thickness of the porous base material from the film thickness of the composite film.

### (Weight Per Unit Area)

A sample was cut into a size of 10 cm×30 cm and the mass thereof was measured. The weight per unit area was obtained by dividing the mass by the area.

### (Coating Amount)

The coating amount of the heat-resistant porous layer was obtained by subtracting the weight per unit area of the porous base material from the weight per unit area of the composite film.

### (Porosity)

When the constituent materials are a, b, c, . . . , and n, and the mass of the constituent materials is represented by Wa, Wb, Wc, . . . , and Wn (g/cm²), the true density thereof is represented by da, db, dc, . . . , and dn (g/cm³), and the film thickness of the layer of interest is represented by t (cm), the porosity ε (%) was obtained according to the following formula.

ε={1−(Wa/da+Wb/db+Wc/dc+ . . . +Wn/dn)/t}×100

### (Gurley Value)

The Gurley value of the separator was measured according to JIS P 8117 using a Gurley-type densometer (G-B2C manufactured by Toyo Seiki Seisaku-sho, Ltd.).

### (Curl Amount)

First, the separator was cut into a size of 40 mm along the MD direction and 40 mm along the TD direction, whereby a sample was prepared. The electricity was removed from this sample by a static eliminator for 10 seconds, and the sample was placed on a planar metal plate with the heat-resistant porous layer facing down. Subsequently, as shown in FIG. 1, a planar weight 2 was placed on a sample 1 such that one edge portion of the sample 1 in the MD direction (A and D in FIG. 1) protruded by 3 mm. The weight weighed 4.5 g, and had a size of 76 mm in length, 26 mm in width, and 1 mm in height. Then, as shown in FIG. 2, the float amount X of the sample 1 at each vertex (A and D in FIG. 1) was measured by digital venire calipers. Subsequently, a weight 2 was placed such that the other edge portion of the sample 1 in the MD direction (B and C in FIG. 1) protruded by 3 mm, and the float amount X of the sample 1 at each vertex (B and C in FIG. 1) was measured by digital venire calipers in the same manner. Then, from the float amounts X of the sample 1 at all the vertices (A, B, C, and D in FIG. 1), the curl amount was calculated according to the following formula 1.

Curl amount−(maximum value of float amount X+minimum value of float amount X)/2 (formula 1)

Incidentally, the float amount X is the amount of height of the curl of the edge portion of the sample in a direction away from the surface of the metal plate, and is a length from the surface of the metal plate to the edge portion of the sample in a direction perpendicular to the surface. Further, the measurement of the float amount is performed in a windless state at room temperature of 23 to 27° C. and a humidity of 40 to 60%. This procedure was performed for 5 samples prepared for each separator, and by calculating an average value of the curl amounts of the 5 samples, the curl amount in the MD direction was obtained.

Also the curl amount in the TD direction was obtained in the same manner. That is, as shown in FIG. 3, a planar weight 2 was placed on a sample 1 such that one edge portion of the sample 1 in the TD direction (A and B in FIG. 3) protruded by 3 mm, and the float amount X at each vertex (A and B in FIG. 3) was measured. Subsequently, a planar weight 2 was placed on the sample 1 such that the other edge portion of the sample 1 in the TD direction (C and D in FIG. 3) protruded by 3 mm, and the float amount X at each vertex (C and D in FIG. 3) was measured. Then, from the float amounts X at the four vertices (A, B, C, and D in FIG. 3), the curl amount was calculated according to the above formula 1, and by calculating an average value of the curl amounts of the 5 samples, the curl amount in the TD direction was obtained.

### Example 1

A coating liquid (an aqueous dispersion) having a solid content concentration of 28.4 mass % was prepared by uniformly dispersing a particulate polyvinylidene fluoride type resin (TRD202A, manufactured by JSR Corporation), magnesium hydroxide (Kisuma 5P, manufactured by Kyowa Chemical Industry Co., Ltd.), carboxymethyl cellulose (CMC), and ion exchanged water. Incidentally, in the coating liquid, adjustment was performed such that the mass ratio of the inorganic filler, the polyvinylidene fluoride type resin, and the CMC was 94.0/5.0/1.0.

As the porous base material, a polyethylene microporous film having a film thickness of 12.4 μm, a Gurley value of 170 sec/100 cc, and a porosity of 35.5% was used. After the surface of this porous base material was subjected to a corona treatment, the above coating liquid was coated on one surface of the porous base material using a bar coater No. 6 with a clearance of 20 μm and dried at 60° C.

By doing this, a separator composed of a composite film in which a heat-resistant porous layer is formed on one surface of the polyethylene microporous film was obtained. In Table 1, the values of various physical properties (a thickness Ta, a coating amount, and a porosity) of the heat-resistant porous layer and the values of various physical properties (a weight per unit area, a film thickness Tb, Ta/Tb, a Gurley value, a value obtained by subtracting the Gurley value of the porous base material from the Gurley value of the composite film (A Gurley value), and curl amounts in the MD direction and in the TD direction) of the separator composed of the composite film are summarized. Also for the following Examples and Comparative Examples, the values of various physical properties are summarized in Table 1 in the same manner.

### Example 2

A separator was obtained in the same manner as in Example 1 except that coating was performed using a bar coater No. 8 with a clearance of 30 μm.

### Example 3

A separator was obtained in the same manner as in Example 1 except that coating was performed using a bar coater No. 6 with a clearance of 30 μm.

### Example 4

A separator was obtained in the same manner as in Example 1 except that coating was performed using a bar coater No. 8 with a clearance of 20 μm.

### Example 5

A separator was obtained in the same manner as in Example 1 except that as the porous base material, a polyethylene microporous film having a film thickness of 16.6 μm, a Gurley value of 163 sec/100 cc, and a porosity of 39.7% was used.

### Example 6

A separator was obtained in the same manner as in Example 5 except that as the inorganic filler, α-alumina (AKP-15, manufactured by Sumitomo Chemical Company, Limited) was used.

### Example 7

A separator was obtained in the same manner as in Example 1 except that as the coating liquid, a coating liquid adjusted such that the mass ratio of the inorganic filler, the polyvinylidene fluoride type resin, and the CMC was 85.0/14.0/1.0 was used.

### Example 8

A separator was obtained in the same manner as in Example 1 except that as the coating liquid, a coating liquid adjusted such that the mass ratio of the inorganic filler, the polyvinylidene fluoride type resin, and the CMC was 98.0/1.0/1.0 was used.

### Comparative Example 1

A coating liquid (an aqueous dispersion) having a solid content concentration of 28.4 mass % was prepared by uniformly dispersing a particulate polyvinylidene fluoride type resin (TRD202A, manufactured by JSR Corporation), magnesium hydroxide (Kisuma 5P, manufactured by Kyowa Chemical Industry Co., Ltd.), carboxymethyl cellulose (CMC), ion exchanged water, and 2-propanol. Incidentally, in the coating liquid, adjustment was performed such that the mass ratio of the inorganic filler, the polyvinylidene fluoride type resin, and the CMC was 94.0/5.0/1.0, and the mass ratio of ion exchanged water and 2-propnol was 80/20.

As the porous base material, a polyethylene microporous film having a film thickness of 12.4 μm, a Gurley value of 170 sec/100 cc, and a porosity of 35.5% was used. After the surface of this porous base material was subjected to a corona treatment, the above coating liquid was coated on one surface of the porous base material using a bar coater No. 8 with a clearance of 30 μm and dried at 60° C.

By doing this, a separator composed of a composite film in which a heat-resistant porous layer is formed on one surface of the polyethylene microporous film was obtained.

### Comparative Example 2

A separator was obtained in the same manner as in Comparative Example 1 except that coating was performed using a bar coater No. 6 with a clearance of 30 μm.

### Comparative Example 3

A separator was obtained in the same manner as in Example 1 except that coating was performed using a bar coater No. 10 with a clearance of 30 μm.

### Comparative Example 4

A separator was obtained in the same manner as in Example 1 except that coating was performed using a bar coater No. 6 with a clearance of 15 μm.

### Comparative Example 5

A separator was obtained in the same manner as in Example 5 except that as the heat-resistant porous layer was formed on both surfaces of the polyethylene microporous film.

### Comparative Example 6

A separator was obtained in the same manner as in Example 1 except that as the coating liquid, a coating liquid adjusted such that the mass ratio of the inorganic filler, the polyvinylidene fluoride type resin, and the CMC was 80.0/19.0/1.0 was used.

TABLE 1

| | Heat-resistant porous layer | | | | | | | | Physical properties of separator | | | | | | |
|---|---|---|---|---|---|---|---|---|---|---|---|---|---|---|---|
| | | | | | | | | | Weight | Film | | | | | |
| | | | | | | Thick- | | | per | thick- | | Gurley | ΔGurley | Curl | Curl |
| | | | Filler | Binder | Lam- | ness | Coating | Po- | unit | ness | | value | value | amount | amount |
| | | | (mass | (mass | inated | Ta | amount | rosity | area | Tb | Ta/ | (s/ | (s/ | MD | TD |
| | Solvent | Filler | %) | %) | surface | (μm) | (g/m²) | (%) | (g/m²) | (μm) | Tb | 100 cc) | 100 cc) | (mm) | (mm) |
| Example | Water | Mg(OH)₂ | 94 | 5 | One | 3.2 | 2.8 | 60.1 | 10.4 | 15.6 | 0.21 | 177 | 7 | 0.43 | 0.27 |
| 1 | | | | | surface | | | | | | | | | | |
| Example | Water | Mg(OH)₂ | 94 | 5 | One | 7.9 | 5.8 | 66.5 | 13.4 | 20.3 | 0.39 | 179 | 9 | 0.29 | 0.16 |
| 2 | | | | | surface | | | | | | | | | | |
| Example | Water | Mg(OH)₂ | 94 | 5 | One | 6.6 | 5.1 | 64.7 | 12.7 | 19.0 | 0.35 | 188 | 18 | 0.31 | 0.18 |
| 3 | | | | | surface | | | | | | | | | | |
| Example | Water | Mg(OH)₂ | 94 | 5 | One | 3.9 | 3.1 | 63.7 | 10.7 | 16.3 | 0.24 | 178 | 8 | 0.34 | 0.18 |
| 4 | | | | | surface | | | | | | | | | | |
| Example | Water | Mg(OH)₂ | 94 | 5 | One | 4.2 | 3.2 | 65.2 | 12.7 | 20.8 | 0.20 | 165 | 2 | 0.14 | 0.09 |
| 5 | | | | | surface | | | | | | | | | | |
| Example | Water | Al₂O₃ | 94 | 5 | One | 5.0 | 3.1 | 71.7 | 12.6 | 21.6 | 0.23 | 173 | 10 | 0.29 | 0.18 |
| 6 | | | | | surface | | | | | | | | | | |
| Example | Water | Mg(OH)₂ | 85 | 14 | One | 4.5 | 3.3 | 64.0 | 10.9 | 16.9 | 0.27 | 198 | 28 | 0.45 | 0.31 |
| 7 | | | | | surface | | | | | | | | | | |
| Example | Water | Mg(OH)₂ | 98 | 1 | One | 3.1 | 2.4 | 65.8 | 10.0 | 15.5 | 0.20 | 174 | 4 | 0.25 | 0.11 |
| 8 | | | | | surface | | | | | | | | | | |
| Com- | Water/ | Mg(OH)₂ | 94 | 5 | One | 5.8 | 4.7 | 63.0 | 12.3 | 18.2 | 0.32 | 208 | 38 | 0.57 | 0.25 |
| parative | IPA | | | | surface | | | | | | | | | | |
| Example | | | | | | | | | | | | | | | |
| 1 | | | | | | | | | | | | | | | |
| Com- | Water/ | Mg(OH)₂ | 94 | 5 | One | 4.9 | 4.1 | 61.8 | 11.7 | 17.3 | 0.28 | 206 | 36 | 0.66 | 0.23 |
| parative | IPA | | | | surface | | | | | | | | | | |
| Example | | | | | | | | | | | | | | | |
| 2 | | | | | | | | | | | | | | | |
| Com- | Water | Mg(OH)₂ | 94 | 5 | One | 8.8 | 8.7 | 54.9 | 16.3 | 21.2 | 0.42 | 184 | 14 | 1.72 | 0.90 |
| parative | | | | | surface | | | | | | | | | | |
| Example | | | | | | | | | | | | | | | |
| 3 | | | | | | | | | | | | | | | |
| Com- | Water | Mg(OH)₂ | 94 | 5 | One | 1.2 | 1.3 | 50.5 | 9.4 | 13.6 | 0.09 | 178 | 8 | 0.33 | 0.24 |
| parative | | | | | surface | | | | | | | | | | |
| Example | | | | | | | | | | | | | | | |
| 4 | | | | | | | | | | | | | | | |
| Com- | Water | Mg(OH)₂ | 94 | 5 | Both | 4.2 | 3.2 | 65.2 | 12.7 | 20.8 | 0.20 | 170 | 7 | 0.15 | 0.06 |
| parative | | | | | surfaces | | | | | | | | | | |
| Example | | | | | | | | | | | | | | | |
| 5 | | | | | | | | | | | | | | | |
| Com- | Water | Mg(OH)₂ | 80 | 19 | One | 7.3 | 5.6 | 60.9 | 13.2 | 19.7 | 0.37 | 220 | 50 | 0.63 | 0.27 |
| parative | | | | | surface | | | | | | | | | | |
| Example | | | | | | | | | | | | | | | |
| 6 | | | | | | | | | | | | | | | |

### [Thermal Shrinkage Rate]

Each of the above separators was cut into a size of 18 cm (MD direction)×6 cm (TD direction), whereby a test piece was formed. A mark was attached on a line bisecting the length in the TD direction at points (point A and point B) at a distance of 2 cm and 17 cm from the upper portion. In addition, a mark was attached on a line bisecting the length in the MD direction at points (point C and point D) at a distance of 1 cm and 5 cm from the left. A clip was attached to the test piece (the place to which the clip was attached was within a distance of 2 cm from the upper portion in the MD direction) and the test piece was suspended in an over, adjusted to 120° C., and a thermal treatment was performed for 60 minutes under tensionless conditions. The lengths between the two points A and B and the two points C and D were measured before and after the thermal treatment, and the thermal shrinkage rate was obtained according to the following formula. The measurement results are shown in Table 2.

Thermal shrinkage rate in MD direction={(length between A and B before thermal treatment−length between A and B after thermal treatment)/length between A and B before thermal treatment}×100

Thermal shrinkage rate in TD direction={(length between C and D before thermal treatment−length between C and D after thermal treatment)/length between C and D before thermal treatment}×100

### [Moisture Amount]

After water was vaporized at 120° C. in a water vaporizer (model: VA-100, manufactured by Mitsubishi Chemical Analytech Co., Ltd.), the moisture amount in the separator was measured using a Karl Fischer Moisture Meter (CA-100, manufactured by Mitsubishi Chemical Corporation). The measurement results are shown in Table 2.

### [Peel Strength]

With respect to each of the above separators, a T-peel test was performed. Specifically, the separator in which a mending tape manufactured by 3M Company was attached to both surfaces was cut into a width of 10 mm, and an edge of the mending tape was pulled at a rate of 20 mm/min by a tension testing machine (RTC-1210A, manufactured by Orientec Co., Ltd.), a stress when the heat-resistant porous layer was peeled off from the porous base material was measured, and an SS curve was created. On the SS curve, stresses were extracted from 10 mm to 40 mm at a pitch of 0.4 mm and averaged. Further, the results of three test pieces were averaged, which was determined to be the peel strength. The measurement results are shown in Table 2.

### [Oven Test]

### (Preparation of Negative Electrode)

300 g of artificial graphite which is a negative electrode active material, 7.5 g of a water-soluble dispersion liquid containing 40 mass % of a modified styrene-butadiene copolymer which is a binder, 3 g of carboxymethyl cellulose which is a thickener, and a proper amount of water were stirred by a double arm mixer, whereby a slurry for a negative electrode was prepared. The slurry for a negative electrode was applied to a copper foil having a thickness of 10 μm which is a negative electrode current collector, and the obtained coated film was dried and pressed, whereby a negative electrode having a negative electrode active material layer was prepared.

### (Preparation of Positive Electrode)

89.5 g of a lithium cobalt oxide powder which is a positive electrode active material, 4.5 g of acetylene black which is a conductive assistant, and 6 g of polyvinylidene fluoride which is a binder were dissolved in N-methyl-pyrolidone (NMP) such that the concentration of polyvinylidene fluoride was 6 mass %, and the resulting mixture was stirred by a double arm mixer, whereby a slurry for a positive electrode was prepared. The slurry for a positive electrode was applied to an aluminum foil having a thickness of 20 μm which is a positive electrode current collector, followed by drying and then pressing, whereby a positive electrode having a positive electrode active material layer was obtained.

### (Preparation of Cell)

A lead tab was welded to the positive electrode and the negative electrode, and these positive and negative electrodes were bonded to each other through each of the above separators, and the resulting material was impregnated with an electrolyte, and enclosed in an aluminum package using a vacuum sealer. Here, as the electrolyte, 1 M LiPF₆ ethylene carbonate/ethyl methyl carbonate (mass ratio: 3/7) was used. A load of 20 kg was applied per square centimeter of the electrode using a hot pressing machine, and the hot pressing was performed at 90° C. for 2 minutes, whereby a test cell was prepared.

### (Evaluation of Heat Resistance)

The cell prepared as described above was charged to 4.2 V. The cell was placed in an oven and a weight of 5 kg was placed thereon. The cell was heated to 150° C. by setting the oven such that the cell temperature was increased at 2° C./min in this state, and a change in the cell voltage at that time was observed. It was determined that the heat resistance was good (G) when there was substantially no change in the cell voltage up to 150° C., and the heat resistance was not good (NG) when a rapid decrease in the cell voltage was observed at a temperature in the vicinity of 150° C. The results are shown in Table 2.

### [Cycling Characteristics (Capacity Retention Ratio)]

10 cells were produced for each separator in the same manner as in the above oven test. With respect to the 1.0 cells produced for each separator, the charging and discharging were repeated at 25° C. by setting the charging conditions to constant current/constant voltage charging at 1 C and 4.2 V, and the discharging conditions to constant current discharging at 1 C and 2.75 V cut-off. A value obtained by dividing the discharge capacity of 100th cycle by the initial capacity was determined to be the capacity retention ratio (%), and an average of the capacity retention ratios of the 10 test cells was calculated. The results are shown in Table 2.

### [Cell Production Efficiency (Winding Properties of Electrode Element)]

With respect to each of the above separators, the cell production efficiency was verified. Specifically, two composite films (width: 108 mm) were disposed such that the heat-resistant porous layers faced each other, and one edge portion of the overlapped separator was wound around a winding core made of stainless steel. In the case of the composite film in which the both surfaces were coated, the composite film could be disposed regardless of which surface was made to face. The positive electrode (width: 106.5 mm) was sandwiched between two composite films, and these members were wound such that the negative electrode (107 mm) was disposed on the porous base material side of one composite film. In this manner, 50 wound electrode bodies were continuously produced, and the production yield of the wound electrode body was confirmed. The production yield was calculated according to the following formula: the number of accepted wound electrode bodies/50 wound electrode bodies×100. The evaluation results are shown in Table 2.

### <Acceptance Criteria for Wound Electrode Body>

A case where the protruding amount of the separator from the positive electrode is within the range of 1.5±0.3 mm, the protruding amount of the separator from the negative electrode is within the range of 1.0±0.3 mm, and the laminated portions of the separators are not misaligned was determined to be accepted. On the other hand, a case where the protruding amount of the separator is outside the above range or the laminated portions of the separators are misaligned was determined to be failed.

### <Evaluation Criteria>

A: The production yield of the wound electrode body is 100%.

B: The production yield of the wound electrode body is 90% or more and less than 100%.

C: The production yield of the wound electrode body is less than 90%.

### [Gas Generation Amount]

Each separator to be a sample was cut into a size of 240 cm² and dried under vacuum at 85° C. for 16 hours. This was placed in an aluminum package in an environment of a dew point of −60° C. or lower, and then, an electrolyte was further injected thereinto, and the aluminum package was sealed with a vacuum sealer, whereby a measurement cell was prepared. Here, as the electrolyte, 1 M LiPF₆ ethylene carbonate (EC)/ethyl methyl carbonate (EMC)=3/7 (weight ratio) (manufactured by Kishida Chemical Co., Ltd.) was used. The measurement cell was stored at 85° C. for 3 days and the volume of the measurement cell was measured before and after the storage. A value obtained by subtracting the volume of the measurement cell before the storage from the volume of the measurement cell after the storage was determined to be the gas generation amount. Here, the measurement of the volume of the measurement cell was performed at 23° C. using an electronic hydrometer (EW-300SG, manufactured by Alfa Mirage Co., Ltd.) according to the Archimedes' principle. The measurement results are shown in Table 2.

TABLE 2

| | Thermal shrinkage rate | | | | | | | Gas |
|---|---|---|---|---|---|---|---|---|
| | 120° C., 60 min | | Moisture | Peel | | | Cell | generation |
| | MD | TD | amount | strength | Oven | Cycling | production | amount |
| | (%) | (%) | (ppm) | (N/cm) | test | characteristics | efficiency | (cc/g) |
| Example 1 | 1.9 | 0.7 | 270 | 0.40 | G | 86 | A | 0.1 |
| Example 2 | 1.2 | 0.4 | 560 | 0.51 | G | 85 | A | 0.1 |
| Example 3 | 1.6 | 0.5 | 490 | 0.44 | G | 88 | A | 0.1 |
| Example 4 | 1.7 | 0.6 | 300 | 0.42 | G | 87 | A | 0.1 |
| Example 5 | 2.0 | 1.2 | 310 | 0.40 | G | 86 | A | 0.1 |
| Example 6 | 3.3 | 1.7 | 220 | 0.45 | G | 87 | A | 7.7 |
| Example 7 | 2.9 | 2.1 | 440 | 0.51 | G | 84 | A | 0.1 |
| Example 8 | 1.8 | 0.6 | 250 | 0.21 | G | 87 | A | 0.1 |
| Comparative | 1.6 | 0.6 | 460 | 0.43 | G | 82 | B | 0.1 |
| Example 1 | | | | | | | | |
| Comparative | 1.6 | 0.6 | 400 | 0.46 | G | 83 | C | 0.1 |
| Example 2 | | | | | | | | |
| Comparative | 1.1 | 0.3 | 840 | 0.60 | G | 84 | C | 0.2 |
| Example 3 | | | | | | | | |
| Comparative | 5.4 | 3.2 | 130 | 0.32 | NG | 77 | A | 0.0 |
| Example 4 | | | | | | | | |
| Comparative | 2.0 | 1.2 | 310 | 0.40 | G | 86 | C | 0.1 |
| Example 5 | | | | | | | | |
| Comparative | 4.8 | 3.0 | 640 | 0.54 | NG | 72 | C | 0.1 |
| Example 6 | | | | | | | | |

[Observation of Surface of Porous Base Material after Peeling Off Heat-Resistant Porous Layer]

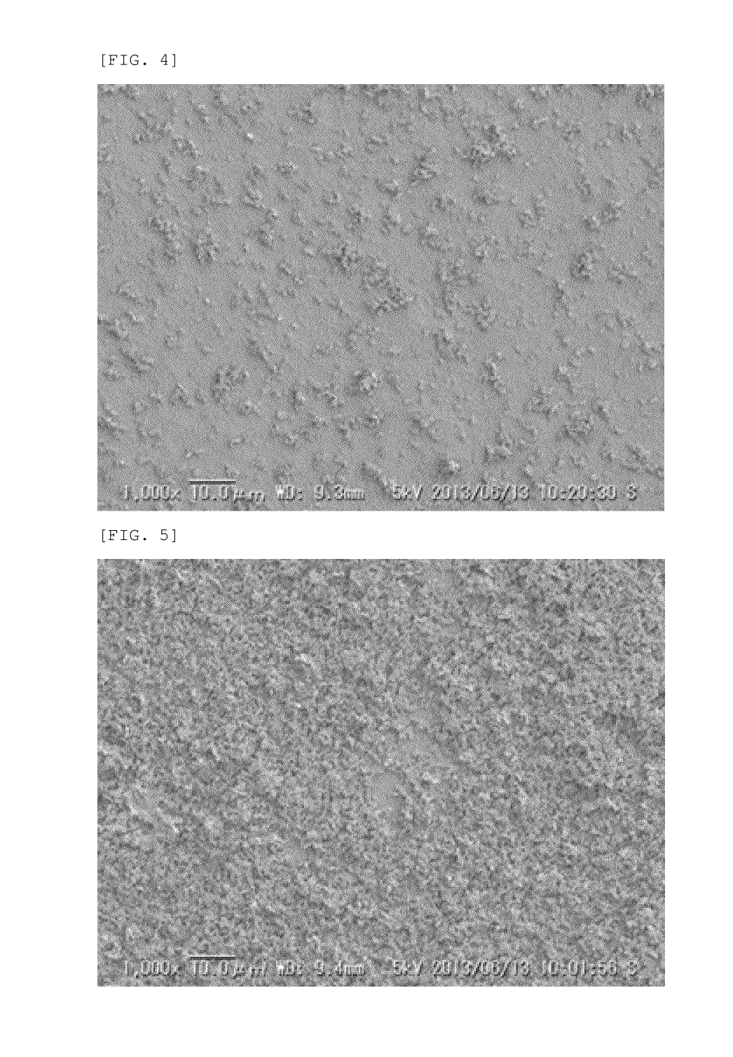

With respect to each of the separators of Example 1 and Comparative Example 1, the surface of the porous base material after the above peel test was observed with an SEM. As the SEM, VE-8800 manufactured by KEYENCE CORPORATION was used, and the acceleration voltage was set to 5 kV. The SEM images (magnification: 1,000 times) of Example 1 and Comparative Example 1 are shown in FIGS. 4 and 5, respectively.

As found from FIG. 4, on the porous base material of Example 1, the residual amount of the heat-resistant porous layer is small. This is considered to be because the morphology of the heat-resistant porous layer in Example 1 is uniform, and therefore, the heat-resistant porous layer could be peeled off evenly. It is considered that in Example 1, the morphology of the heat-resistant porous layer is uniform, and also the ratio of the film thickness between the heat-resistant porous layer and the composite film is appropriately controlled, and therefore, the curl amount can be reduced to 0.5 mm or less.

On the other hand, as shown in FIG. 5, on the porous base material of Comparative Example 1, the residual amount of the heat-resistant porous layer is large. This is considered to be because the morphology of the heat-resistant porous layer in Comparative Example 1 is not uniform, and therefore, the heat-resistant porous layer was partially left on the surface of the porous base material without being peeled off. Therefore, it is considered that in Comparative Example 1, even if the ratio of the film thickness between the heat-resistant porous layer and the composite film is within the range of the invention, the morphology of the heat-resistant porous layer is not uniform, and thus, the curl amount is outside the range of the invention.

1. A non-aqueous secondary cell separator, comprising
a composite film including
a porous base material containing a thermoplastic resin and
a heat-resistant porous layer provided on one surface of the porous base material and containing an organic binder and an inorganic filler, wherein
the organic binder is a particulate polyvinylidene fluoride type resin, and the heat-resistant porous layer has a porous structure in which the particulate polyvinylidene fluoride type resin and the inorganic filler are connected to each other,
the ratio of the thickness Ta of the heat-resistant porous layer to the thickness Tb of the composite film (Ta/Tb) is 0.10 or more and 0.40 or less,
the content of the inorganic filler in the heat-resistant porous layer is 85 mass % or more and 99 mass % or less with respect to the total mass of the organic binder and the inorganic filler, and
the curl amounts of the composite film in the longitudinal direction and in the width direction are both 0.5 mm or less.

2. The non-aqueous secondary cell separator according to claim 1, wherein the thermal shrinkage rate of the composite film in the longitudinal direction and in the width direction when the composite film is subjected to a thermal treatment at 120° C. for 60 minutes is 3% or less.

3. The non-aqueous secondary cell separator according to claim 1, wherein the moisture amount in the composite film is 2,000 ppm or less.

4. The non-aqueous secondary cell separator according to claim 1, wherein a value obtained by subtracting the Gurley value of the porous base material from the Gurley value of the composite film is 30 sec/100 cc or less.

5. The non-aqueous secondary cell separator according to claim 1, wherein the heat-resistant porous layer further contains a thickener.

6. The non-aqueous secondary cell separator according to claim 1, wherein the thickness Ta of the heat-resistant porous layer is 2 μm or more and less than 8 μm.

7. A non-aqueous secondary cell comprising a positive electrode, a negative electrode, and the non-aqueous secondary cell separator according to claim 1 disposed between the positive electrode and the negative electrode, wherein an electromotive force is obtained by doping and dedoping of lithium.

8. The non-aqueous secondary cell separator according to claim 2, wherein the moisture amount in the composite film is 2,000 ppm or less.
